(19) United States
(12) Patent Application Publication
(10) Pub. No.: US 2012/0050909 A1
(43) Pub. Date: Mar. 1, 2012

(54) TAPE GUIDE ROLLER

(75) Inventors: Mark Alfred Lantz, Rueschlikon (CH); Hugo E. Rothuizen, Rueschlikon (CH)

(73) Assignee: INTERNATIONAL BUSINESS MACHINES CORPORATION, Armonk, NY (US)

(21) Appl. No.: 13/197,257

(22) Filed: Aug. 3, 2011

(30) Foreign Application Priority Data
Aug. 30, 2010 (EP) EP10174531.3

(51) Int. Cl. G11B 15/18; G11B 15/00

(52) U.S. Cl. 360/71; 360/90; G9B/15.021; G9B/15

(57) ABSTRACT

There is disclosed a tape guide roller for guiding a tape (11) in a tape storage. The tape guide roller is tiltable such that by tilting the tape guide roller the tape (11) may be returned from a laterally offset position to a centered position. An actuator (1560) of the tiltable tape guide roller is implemented as a magnetic actuator with a permanent magnet assembly (1570) and an electromagnet a pole piece (1702) of which electromagnet is facing the magnet assembly (1570). The width (W1) of the pole piece (1702) is smaller than the width (W2) of the magnet assembly (1570). As a result the tape guide roller may be operated in a power efficient way.

### RELATED APPLICATION(S)

This application claims priority under 35 U.S.C. §119 or 365 to European Application No. 10174531.3, filed Aug. 30, 2010. The entire teachings of the above application(s) are incorporated herein by reference.

### FIELD OF THE INVENTION

The present invention relates to a tape guide roller for guiding a tape of a tape drive storage system.

### BACKGROUND

Tape drive systems for reading and writing data to/from a tape storage medium—in short tape—are widely used, in particular for archiving purposes. The tape typically is contained in a cartridge of one or two reels, and the tape is moved between a supply reel and a take up reel. Such tape may have a plurality of data tracks extending in the longitudinal direction, and the tape drive system may provide a track following servo system for moving the tape head in a lateral direction for following lateral movement of the longitudinal tracks as the tape is moved in the longitudinal direction. The track following servo system may employ servo tracks on the tape which are in parallel to the data tracks, and employ servo read heads to read the servo tracks to detect position. As a result, the tape head may be repositioned and be realigned with the data tracks.

Improving the read performance of a tape drive system is limited due to a phenomenon referred to as tape skew. Nominally, the long axis of the tape should be perpendicular to the long axis of a tape head for reading and writing to/from tape. Tape skew is a measure of the deviation from perpendicularity of the angle of the tape relative to the tape head.

Tape skew may be constrained by tape guides for controlling the lateral movement of the tape as the tape is moved along a tape path in a longitudinal direction across a tape head. Tape guides can to an extent limit at least the amplitude of the lateral movement of the tape with the goal of limiting the lateral movement so that it does not exceed the lateral movement capability of the track following servo system.

Tape guides may comprise edges or flanges arranged at the side of tape guide rollers and may be positioned against the edges of the tape to control the amplitude of the lateral movement of the tape. The associated tape guide roller is generally rotatable about a central axis parallel to its cylindrical peripheral surface allowing the tape freedom of movement in the longitudinal direction.

When the tape comes into contact with these tape guide flanges, high frequency lateral tape motion can result which is difficult for the track following servo system to follow, and can result in tape edge damage. This tape edge damage can in turn result in the build up of debris on the flanges which can further excite high frequency lateral tape motion when it hits the tape edge.

Recently, a flangeless, tiltable tape guide roller was introduced. Such a tape guide roller provides for an actuator adapted to pivot a tape roller surface of such tape guide roller to control the lateral position of the tape when a sensed tape position indicates a deviation from the desired tape position or the presence of tape skew.

### BRIEF SUMMARY OF THE INVENTION

According to one aspect of the invention, there is provided a tape guide roller, comprising a first support frame including a return path structure formed of a magnetically permeable material, a second support frame pivotally coupled to the first support frame, and an actuator for tilting the first support frame against the second support frame. The actuator comprises a coil supported by said first support frame for conducting an electric current to generate a magnetic field conducted by the return path structure, and a permanent magnet assembly supported by the second support frame, the magnet assembly facing a pole piece of the return path structure. The width of the pole piece is smaller than a width of the magnet assembly.

In embodiments, the tape guide roller may comprise one or more of the following features:
the width of the pole piece is half of the width of the magnet assembly,
the width of the pole piece is within a range of 20% to 80% of the width of the magnet assembly,
the width of the pole piece is within a range of 30% to 70% of the width of the magnet assembly,
the width of the pole piece is within a range of 40% to 60% of the width of the magnet assembly,
the width of the pole piece is within a range of 45% to 55% of the width of the magnet assembly,
the return path structure includes a core around which the coil is wound and a member extending from the core, wherein the pole piece is arranged at the end of the member,
the pole piece is an element manufactured separately from the member, and wherein the pole piece is attached to the member,
the width of the pole piece is different to a width of the member,
the return path structure includes a second member parallel to the first member each member extending from an end of the core, and wherein the magnet assembly extends between the members of the return path structure,
the magnet assembly comprises a first and a second permanent magnet supported by the second support frame, wherein the second support structure is pivotally coupled to the first support structure at a pivot point located between the first and second magnets,
the magnet assembly comprises one or more magnets with a face facing the pole piece, the face comprising portions of opposite magnetic polarity,
at least part of the return path structure is made of a mu-metal or a silicon steel, or other low hysteresis soft magnetic material,
the actuator is designed such that magnetic attraction between the magnet assembly and the return path structure holds the second support frame and the tape roller barrel in a first position relative to the first support frame and that current conducted through the coil generates a magnetic field which is conducted by the return path structure to interact with the magnetic field of the magnet which causes the second support frame and the tape roller barrel to pivot relative to the first support frame as a function of the magnitude and direction of the current through said coil.
the second support frame supports a rotatable tape roller barrel for guiding a tape of a tape storage system, which tape roller barrel has a grooved surface.

According to another aspect of the invention, there is provided a tape drive system comprising a tape head, a tape drive for moving a tape inserted into the tape drive in a longitudinal direction across the tape head, a tape position sensor for detecting a lateral position of the tape, and a tape guide roller according to any one of the embodiments above. Further, there is provided a controller responsive to the tape position sensor for controlling the current through the coil to tilt the tape roller barrel to control the lateral position of the tape.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1 a schematic diagram of a tape drive system according to an embodiment of the present invention,

FIG. 2 in its diagrams a, b and c, various alignments of a tape head versus a tape,

FIG. 3 a perspective view of a tiltable tape guide roller according to an embodiment of the present invention,

FIG. 4 a longitudinal cut of the tape guide roller of FIG. 3,

FIG. 5 a second support frame as used in the tape guide roller of FIG. 4 according to an embodiment of the present invention, in a perspective view in FIG. 5a, and in a front view in FIG. 5b ,

FIG. 6 a side view of an actuator of a tape guide roller according to an embodiment of the present invention, in an untilted position in FIG. 6a, and in a tilted position in FIG. 6b ,

FIG. 7 in its diagrams a, b and c, a top schematic view of embodiments of the interaction of the permanent magnet assembly and the pole piece of a magnetic return path structure facing the magnet assembly in an actuator of a tiltable tape guide roller in accordance with an embodiment of the present invention, and

FIG. 8 in its diagrams a and b, schematic perspective views of actuators of tape guide rollers according to various embodiments of the present invention.

### DETAILED DESCRIPTION OF THE EMBODIMENTS

As an introduction to the following description, it is first pointed at a general aspect of the invention concerning a tape guide roller. The tape guide roller is formed as a tiltable tape guide roller which can be used in combination with a tape edge sensor or, more generally, a tape position sensor for detecting the lateral position of the tape, in a—e.g. active closed control—feedback loop to actively steer the tape to mitigate the effects of lateral tape motion and tape skew. For such a tape guide roller to become tiltable there is provided an actuator for tilting a first support frame of the tape guide roller against a second support frame. The first support frame includes a return path structure formed of a magnetically permeable material which is designed for guiding a magnetic field generated by an electric current in a coil supported by the first support frame. The second support frame is pivotally coupled to the first support frame and preferably supports a rotatable tape roller barrel for guiding the tape. The second support frame further supports a permanent magnet assembly which faces at least one pole piece of the return path structure. The magnet assembly is defined as an element comprising one or more magnets for interacting with the pole piece of the electromagnet formed by the coil, the return path structure and the pole piece.

It is recognized that tilting the tape roller barrel of a tape guide roller can introduce a gradient of tension between the top and bottom edges of the tape which can be used to actively steer the tape riding on the tape roller barrel.

In order to improve the power consumption of such actuator, a width of the pole piece is designed smaller than a width of the magnet assembly. Reducing the width of the pole piece with respect to the width of the magnet assembly may generate more force and more displacement for the same power as if the width of the pole piece and the magnet assembly were equal. In addition, by means of material design of the return path structure, a hysteresis property of the actuator may be improved.

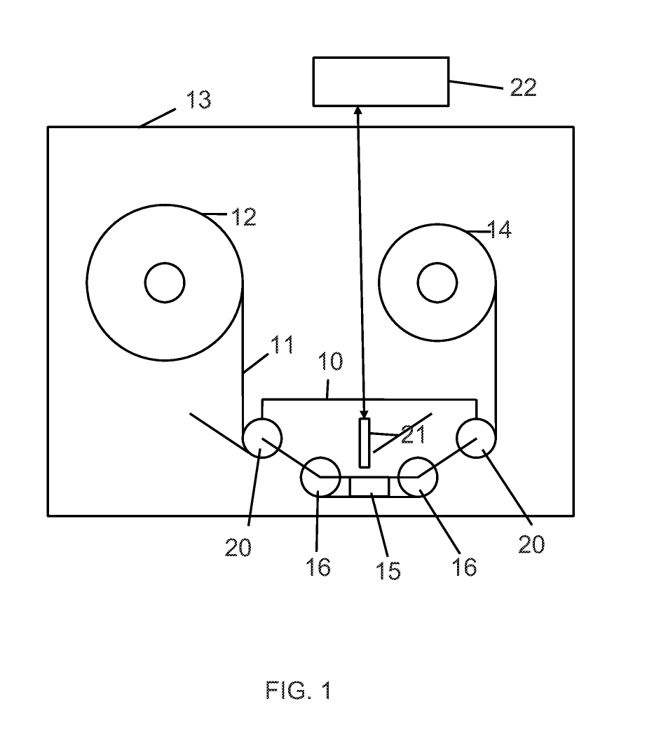

FIG. 1 schematically illustrates a tape drive system, such as a magnetic tape drive system, in accordance with an embodiment of the present invention. In FIG. 1, a tape cartridge 13 is inserted into a tape drive. The cartridge 13 includes a magnetic tape 11 which is moved along a tape path from a supply reel 12 to a take up reel 14. The reel 12 is arranged in the cartridge 13, too. The reels 12, 14 may be operated by drive motors which may be arranged in the tape drive. When the cartridge 13 is inserted in the tape drive and the drive motors are activated, the magnetic tape 11 is moved along a tape path in a longitudinal direction across a tape head 15 of the tape drive. The tape head 15 includes various read and write elements for reading data from and writing data to the tape 11.

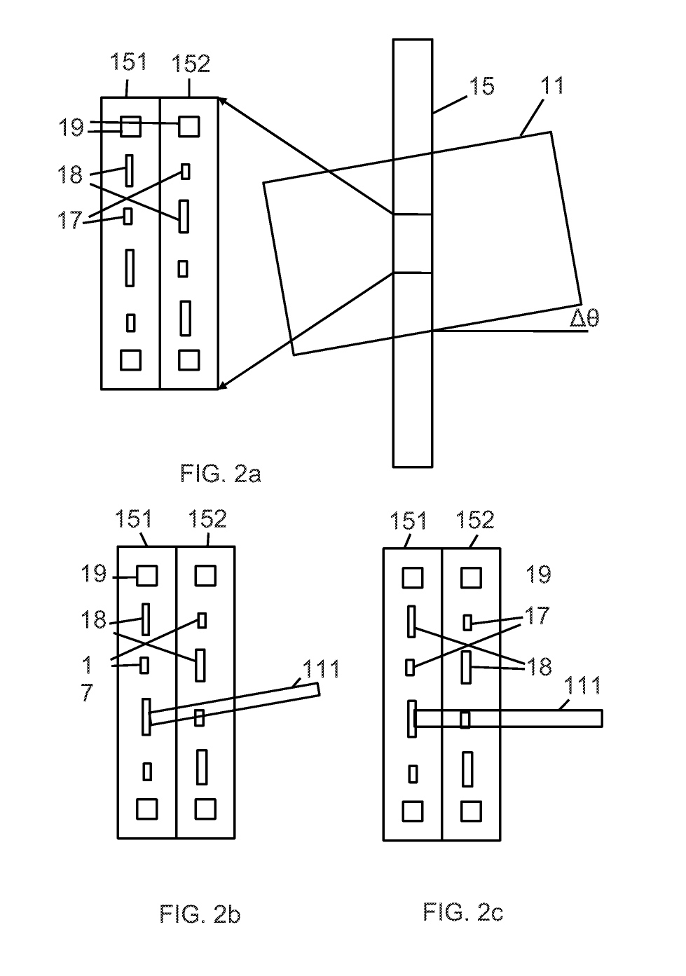

Various positions of a tape head 15 versus a tape 11 are illustrated in diagrams in FIGS. 2a to 2c. All diagrams illustrate a top view on a tape 11 passing a tape head 15 of the tape drive. Only a limited section of the tape 11 is shown in FIG. 2a), and only a single data track 111 of the tape 11 is schematically illustrated in diagrams 2b) and 2c) although it is understood that typically there are multiple data tracks provided on the tape 11. In addition, there may be provided one or more servo tracks on the tape 11 containing servo patterns supporting the detection of a lateral shift of the tape 11. The servo tracks may comprise any of several types of longitudinal servo patterns as is known to those of skill in the art. For example, the tape may comprise five longitudinal servo tracks each prerecorded with a timing based servo pattern is described in U.S. Pat. No. 5,689,384, and comprises magnetic transitions recorded at more than one azimuthal orientation across the width of the servo track.

In the present example, the magnetic tape 11 may be provided with four data bands between each two servo tracks each data band comprising multiple data tracks. The tape head 15 in FIG. 1 includes a plurality of read elements 17 and write elements 18 for reading and/or writing data on the tape 11. The system reliability is enhanced by performing a read operation simultaneously with a write operation. This is implemented by using two tape head modules 151 and 152 as indicted in FIG. 2. On each module 151, 152, read elements 17 alternate with write elements 18. The second head module 152 is physically attached, e.g. glued, to the first head module 151 with read elements 17 that are aligned with the write elements 18 of the first head module 151 in the direction of tape motion. Such elements 17, 18 on different modules 151, 152 may be spaced from each other e.g. at 1.5 mm. Data is written as the tape 11 moves over the first head module 151 and is then read back and verified as the written data passes over the second head module 152. If too many raw errors are detected in the written data, the data can be immediately rewritten without stopping the tape 11. When the tape 11 is moved in opposite direction, adjacent read and write elements 17 and 18 are responsible for first writing and then reading the written data for verification purposes. The read and write elements may also be arranged in a different way, e.g. with the read elements being positioned on top of the write elements, with the center of the read element aligned with the center of the write element, and the read elements and writer elements of one head module being aligned with the read elements and write elements of the other head module.

In addition to the read and write elements 17 and 18 there are provided servo read elements 19 which are properly positioned at the specific servo tracks. The servo read elements 19 are part of a track following servo system for moving the tape head 15 in a lateral direction, i.e. a direction orthogonal to the longitudinal direction of the tape, for following lateral movement of the longitudinal tracks as the tape 11 is moved in the longitudinal direction, and thereby reposition the tape head 15 at the data tracks for following the data tracks. The track following servo system may comprise a coarse actuator, such as a stepper motor, and a fine actuator, such as a voice coil, mounted on the coarse actuator. The fine actuator in this embodiment has a high bandwidth for a very limited lateral movement, called “fine” track following, for allowing the tape head 15 to accurately follow small displacements of the tape 11. Larger movement of the tape head 15 is in this embodiment conducted by the coarse actuator for centering the actuator at the average position of the fine actuator during track following, and is also employed to shift the tape head from one set of tracks to another set, and is conducted at a slow rate.

A challenge arising in performing read while write verification is due to a phenomenon referred to as tape skew. Nominally, the long axis of the tape 11 should be perpendicular to the long axis of the tape head 15. Tape skew indicated by tape skew angle Δθ in FIG. 2a is a measure of the deviation from perpendicularity of the angle of the tape 11 relative to the tape head 15. Specifically, as can be seen from FIG. 2b a data track 111 assigned to a sequence of a read element 17 and a write element 18 now is inclined with respect to the read and write element 17 and 18 such that the data may not be read properly during read while write verification. Specifically, if the tape skew angle Δθ becomes too large, the read element 17 gets out of alignment with the associated data track 111. Hence, such misalignment between the elements 17, 18 and the corresponding data track results in an assumed write error. Instead, a proper tape movement in which the long axis of the tape 11 is orthogonal to the long axis of the tape head 15 is desired. Then, the individual tracks can be properly written and read. Such arrangement is shown in FIG. 2c.

Tape skew cannot fully be cured by the track following servo system for the reason that tape skew includes a rotational component which the track following servo system may not be able to cope with, and tape skew may include a lateral offset of the tape that may be too large to be handled by the track following servo system. Tape skew arises e.g. when the tape is wound on a reel, as then it is typically subjected to rapid lateral transient shifting, for example, from stack shifts or stagger wraps, in which one wrap of the tape is substantially offset with respect to an adjacent wrap. Other common sources of rapid lateral transient shifts resulting in tape skew include 1) a buckled tape edge in which the tape crawls against a tape guide flange and suddenly shifts laterally back down onto the bearing, 2) a damaged edge of the tape which causes the tape to jump laterally when contacting a tape guide, and 3) when the take up reel or supply reel runout is so significant that the reel flange hits the edge of the tape.

The present embodiment proposes to use a flangeless tape guide roller that is tiltable via a built-in actuator. Such a tiltable tape guide roller can be used in combination with a tape edge sensor in a feedback loop to actively steer the tape to mitigate the effects of lateral tape motion and tape skew.

Returning to the tape drive system of FIG. 1, there are provided two of such flangeless tape guide rollers 16 arranged closely adjacent the tape head 15. Each tape guide roller 16 preferably has a tape roller barrel with a cylindrical peripheral surface parallel to the lateral direction of the tape 11 and a height or length of the tape roller barrel extending the width of the tape 11 for contacting a surface of the tape 11. In the illustrated embodiment, the height of the tape roller barrel is chosen to be e.g. 16 mm to comfortably handle possible lateral excursions of a half-inch (12.7 mm) wide tape 11. It is appreciated that other dimensions may be selected depending upon the particular application. Each tape guide roller 16 is rotatable about a central axis parallel to the cylindrical peripheral tape engagement surface allowing the tape freedom of movement in the longitudinal direction and also countering stiction.

The peripheral surface of each tape guide roller 16 is tiltable to control the lateral position of the moving tape. In the illustrated embodiment, the peripheral surface of each tape guide roller 16 is tiltable about an axis orthogonal to the axis of rotation of the tape guide roller 16.

In one embodiment, tape guide rollers 16 may be positioned outside the cartridge 13, for example in a tape head support 10 as shown in FIG. 1. In another embodiment, the tape guide rollers may be located within the removable cartridge 13. When the cartridge 13 is placed in the tape drive, the tape guide rollers 16 are positioned along the tape path, and adjacent to the tape head 15.

It is understood that subject to the application there may be no need to provide two tiltable tape guide rollers 16 and providing only a single tiltable tape guide roller 16 may be sufficient. In addition, one or more non-tiltable tape guide rollers 20 may be provided subject to the application and the mechanical set-up of the tape drive system. These non-tiltable tape guide rollers 20 may also provide conventional flanges for reducing the amplitudes of the lateral transient movement as needed.

The tape drive additionally comprises a controller 22 which provides the electronics modules and processor to implement a track following servo system to operate a compound servo actuator. In addition, the controller 21 provides the electronics modules and processor portion of the tape guide rollers 16 as described herein. A tape position sensor 21 indicates a lateral offset of the tape 11 indicating tape skew based on which information the controller 22 may want to tilt the one or more tape guide rollers 16. In more detail, the operation of such a tape guide roller may include tilting the tape roller barrel which is engaged with a surface of the longitudinally moving tape. Such initial position of the tape guide roller may be a non-tilted position relative to the longitudinal tape path. The magnetic attraction between the magnet assembly of the tape guide roller and the return path structure of magnetically permeable material is used to bias the tape roller barrel in such first, untilted position. In another step, the sensor 21 may sense a lateral position of the tape 11 deviating from the center position. In response to the detection of the lateral deviation, the tape guide roller including its tape roller barrel is tilted by using the actuator. In one embodiment, at least a portion of any air bearing between the moving tape and the tape roller barrel surface may be quenched using grooves or any other structures on the surface of the tape roller barrel so that the tape is constrained to move in the same direction as the tilting tape roller barrel. Thus, when the tape guide roller is requested to tilt, the tape roller barrel tilts, which moves the tape back towards its center position. In this manner, deviation of the tape from the center position may be corrected.

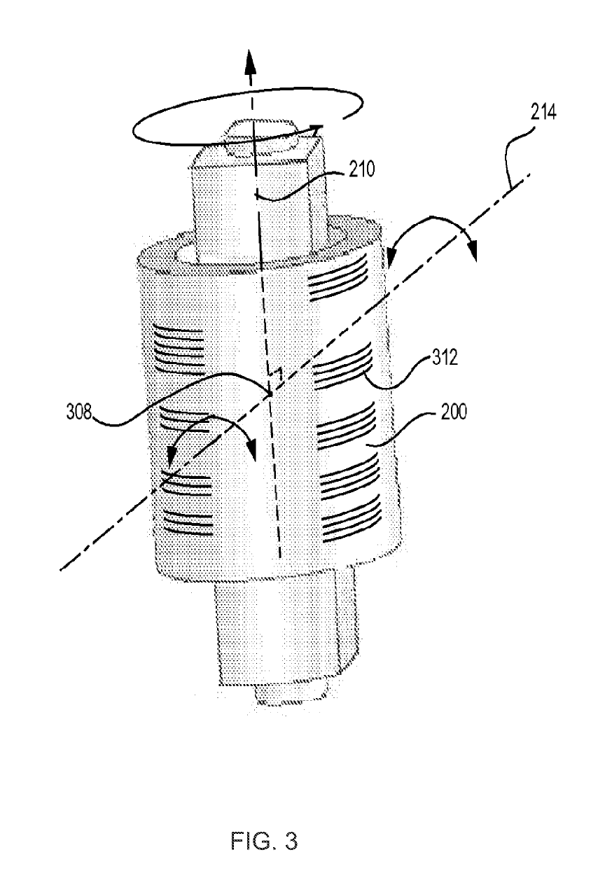

FIG. 3 illustrates a perspective view of a tiltable tape guide roller according to an embodiment of the present invention. The tape guide roller rotates around its longitudinal axis 210 which rotation is indicated by an elliptic arrow. In the illustrated embodiment, the tape guide roller and in particular its tape engagement surface 200 with grooves 312 thereon is tiltable about axis 214, which, in this embodiment, is generally orthogonal to the axis 210 of rotation of the tape guide roller which axis 210 and 214 meet in point 308. The tilting movement is indicated by two double arrows around axis 214.

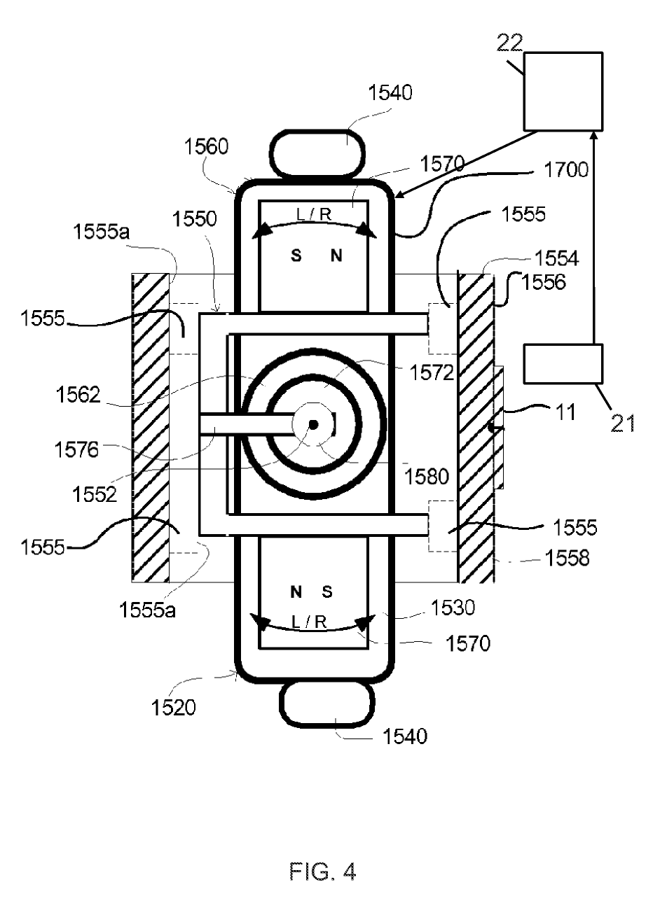

FIG. 4 represents a longitudinal cut of the tape guide roller of FIG. 3. The tape guide roller has a base 1520 which has a fixed, first support frame 1530. Mounting caps 1540 at the top and bottom, respectively, of the first support frame 1530 may be used to locate and fasten the tilting tape guide roller to the tape drive. A second support frame 1550 is pivotally coupled at a pivot 1552 to the fixed first support frame 1530. A tape roller barrel 1554 of the tape guide roller is rotatably supported by roller bearing tracks 1555 disposed around the second support frame 1550. The roller barrel 1554 is positioned along a tape path, and in this example, the surface 1556 of the roller barrel 1554 defines a plurality of grooves 1558, or notches, so that the surface 1556 is adapted to contact and engage the surface of the tape 11 as the roller barrel 1554 rotates. The tape guide roller includes an actuator 1560 coupled to both the first support frame 1530 and the second support frame 1550 and is adapted to pivot the second support frame 1550 and the roller barrel 1554 at the pivot 1552 relative to the first support frame 1530 when the actuator 1560 is actuated. In the illustrated embodiment, the actuator 1560 is a voice coil actuator.

FIG. 4 further schematically indicates a tape position sensor 21 arranged to detect the lateral position of the tape 11. A controller 22 is adapted to control the actuator 1560 to tilt the roller barrel 1554 on the pivot axis 214 to control the lateral position of the tape 11 in response to the information supplied by the tape position sensor 21.

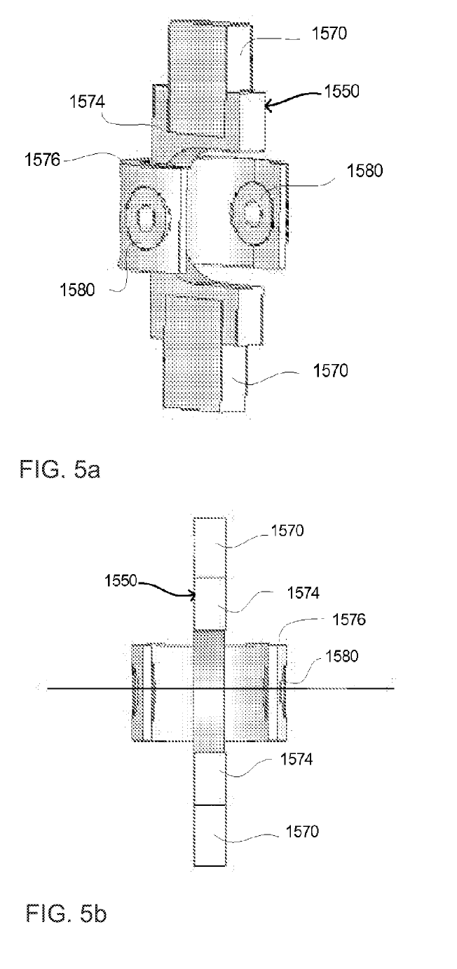

FIG. 5 illustrates a second support frame of a tape guide roller according to an embodiment of the present invention, in a perspective view in FIG. 5a), and in a front view in FIG. 5b). The second support frame 1550 which is expected to extend around a coil not shown in FIG. 5 supports a first U-shaped magnet holder 1574. The magnet holder 1574 holds a magnet assembly 1570. The magnet holder 1574 is connected by a second U-shaped swing arm 1576 to a pivot point 1552. The swing arm 1576 may be affixed to the magnet holder 1574 orthogonal to the magnet holder 1574. A pivot pin of the first support frame is provided to enable the second support frame 1550 to pivot around the pivot point 1552. Ball bearing tracks 1580 between the pivot pin 1552 and the second U-shaped swing arm 1576 facilitate the swing arm 1576 and hence, the magnet holder 1574 and the magnet assembly 1570, pivoting about the pivot point 1552.

Returning to FIG. 4, the tape guide roller further includes a magnetic return path structure to conduct a magnetic field generated by a coil 1562. The magnetic return path structure is, in the illustrated embodiment, a part of the first support frame 1530, and includes a pair of parallel return members 1700, each of which has a pole piece (not shown) extending from each end. The magnetic return structure further includes a core 1572 around which the coil is wound. The core 1572 also functions as the coil holder. The core 1572 of the return path structure connects the centers of the parallel return members 1700. The magnetic return path structure may be made of a ferromagnetic material such as nickel, iron, steel or suitable magnetically permeable materials. The second U-shaped swing arm 1576 of the first support frame extends around the magnetic return structure and is rotatably journaled to the pivot pins 1552 extending from the magnetic return path structure.

The permanent magnet assembly 1570 supported by the magnet holder 1574 of the second support frame 1550 is positioned between and facing each of the pole pieces of the return path structure. The magnetic attraction between the magnet assembly 1570 and the return path structure biases the magnet assembly 1570 and hence, the second support frame 1550 in a first, nontilted position relative to the return path structure of the first support frame 1530.

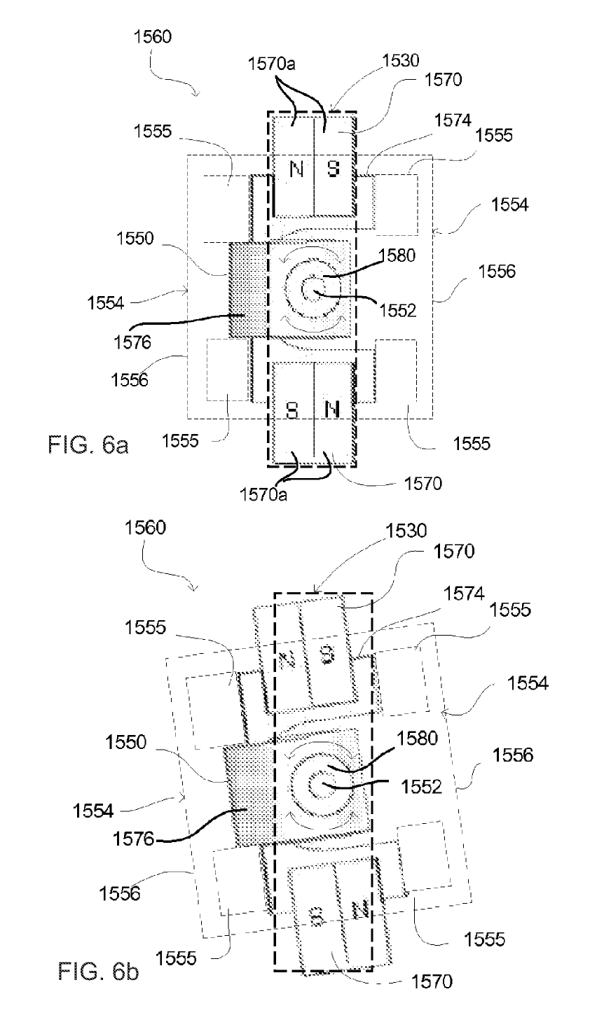

Such position is shown in the longitudinal cut of a tape guide roller in FIG. 6a. Conversely, to tilt the tape roller barrel 1554, the controller 22 causes current to be conducted through the coil 1562 which generates a magnetic field which is conducted by the return path structure to interact with the magnetic fields of the magnet assembly 1570. This magnetic field interaction causes the magnet assembly 1570 and hence, the second support frame 1550 and the tape roller barrel 1554 to pivot on pivot 1552 relative to the return path structure of the first support frame 1530, as a function of the magnitude and direction of the current through the coil 1562 as shown in FIG. 6b.

As a result, the tape roller barrel 1554 tilts, too, as it follows the tilting movements of the second support frame. The tape roller barrel 1554 is rotatably supported by two spaced apart roller bearing tracks 1555, each of which is affixed to an end of the pivoting magnet holder 1574 of the second support frame 1550. Each roller bearing track 1555 defines an interior opening 1555a through which the parallel return members 1700 of the return path structure extend. The roller bearing tracks 1555 in turn engage the internal surface of the roller barrel 1554, wherein the roller barrel 1554 is adapted to rotate on the roller bearing tracks 1555 around the magnet holder 1574 of the second support frame 1550. In the illustrated embodiment, the roller bearing tracks 1555 may include ball bearings, an air bearing, or other suitable bearings. The barrel surface 1556 may be textured, that is, grooved, to enhance lateral friction to a degree between the tape and the engagement surface 1556. Because the air bearing is substantially quenched in the present embodiment, little or no tension gradient is developed across the tape. Nonetheless, tape 11 is constrained to move in the same direction as the tilting motion of the barrel of the grooved roller.

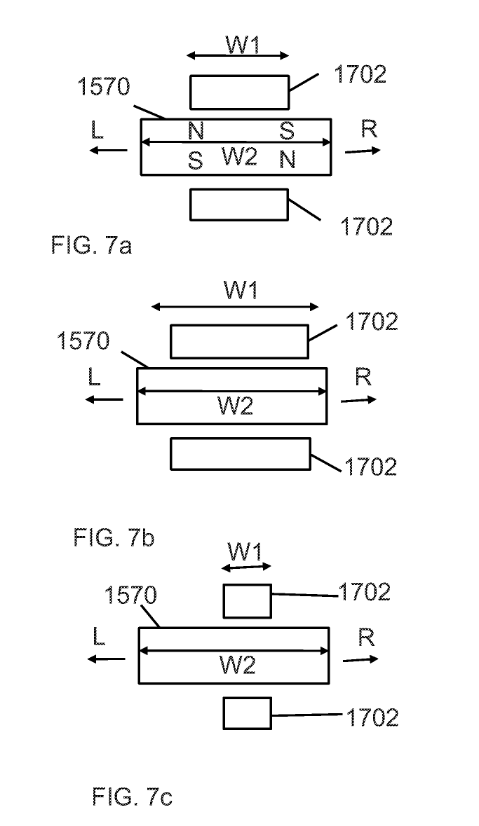

In operation, current through the coil 1562 produces a magnetic field directed by the return path structure to be normal to the plane of FIG. 4 and parallel and antiparallel to the magnetic fields of the magnet assembly 1570. For a better illustration, it is referred to FIG. 7 which in its diagrams a, b and c shows a top, schematic view of embodiments of the interaction of the permanent magnet assembly 1570 with pole pieces 1702 of a magnetic return path structure facing the magnet assembly 1570 in an actuator of a tiltable tape guide roller in accordance with an embodiment of the present invention. Thus, the fixed coil produces a flux which, depending on the current direction adds to or subtracts from the field due to the magnet assembly 1570. In the illustrated embodiment of FIG. 7a, the magnetic polarities of the magnet assembly 1570 may be arranged to alternate as indicated by “N” and “S”, and as such are magnetically polarized oppositely by halves as shown. Thus, the flux from the coil through the return path structure increases the field of one half of the magnet assembly 1570 and decreases the field of the other half. This changes the magnetic energy in the air gap field. As a result, the gradient of the magnetic energy becomes non-zero and a force is generated. It is appreciated that the magnetic polarizations may be achieved using a variety of techniques including fabricating one or more separate permanent magnets into a magnet assembly of different polarizations. The magnet assembly 1570 may have a face with different polarizations wherein each polarization is provided by a separate magnet or a portion of a magnet. Also, the relative proportions of the different polarizations may vary, depending upon the particular application. In the illustrated embodiment, the resulting forces applied to the magnets 1570 causing deviation are in the left/right (L/R) direction depending upon the current direction. These forces cause a tilting of the tape guide roller about the pivot 1552.

In the previous embodiments, the pole pieces 1702 form the elements of the return path structure which face the magnet assembly. According to FIG. 7, each of the pole pieces 1702 has a width W1. In turn, the magnet assembly 1570 has a width W2. Width W1 is smaller than width W2 in the embodiments of FIG. 7.

It was observed that the power efficiency of an actuator design according to which the pole piece 1702 of the magnetic return path structure facing the magnet assembly 1570 has a smaller width W1 than the width W2 of the magnet assembly 1570 is improved compared to embodiments where the widths W1 and W2 are equal or where the width W1 exceeds width W2. Reducing the width W1 of the protruding section of the return path, i.e. the pole piece 1702, affects both the amount of force generated for a given input current/power as well as the effective stiffness of the actuator, i.e. the magnitude of tilt angle generated for a given applied force.

In a first embodiment as shown in FIG. 7a, the width W1 of the pole piece 1702 is roughly half of the width W2 of the magnet assembly 1570. “Roughly half” includes a tolerance of at max. plus/minus 2%. When implementing such geometric proportions, it was found that an increase in stiffness of ˜25%, and an increase in force of ˜400% was achieved at an applied current of 0.4 A relative to a design in which the width W1 of the pole piece 1702 equals the width W2 of the magnet assembly 1570. In the present example, the width W2 of the magnet assembly 1570 may advantageously be 5 mm, and the width W1 of the protruding section, i.e. the pole piece 1702, may advantageously be 2.5 mm.

Reducing the width W1 of the pole piece 1702 further to 2.0 mm produces an additional ˜4% more force and results in an additional ˜12% lower stiffness, whereas increasing the width W1 from 2.5 mm to 3.0 mm results in a ˜7% lower force and a 21% increase in stiffness. Thus by tuning the width W1 of the pole piece 1702 force, stiffness and displacement can be traded off.

FIGS. 7b and 7c illustrate variations of the width W1 of the pole piece 1702. In FIG. 7b width ratio W1/W2 is about 70%, and in FIG. 7c width ratio W1/W2 is about 25%.

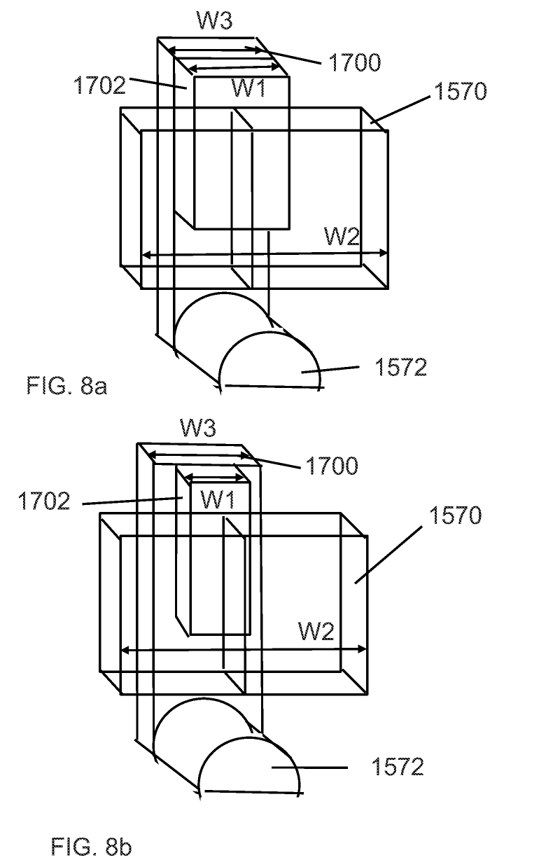

FIG. 8 illustrates in a perspective view magnet assembly/return path structure configurations according to embodiments of the present invention, wherein the magnet assembly 1570 is drafted in a transparent fashion such that the associated return path structure remains visible. The magnet assembly 1570 comprises two magnets. The return path structure comprises a return member 1700, and a core 1572 for supporting a coil not shown, the return member 1700 and the core 1572 may be formed by a single piece of material. Preferably, a second return member not shown may extend from the second end of the core 1572 and face the magnet assembly, too, such that the magnet assembly 1570 is arranged between the two return members 1700. The return path structure further includes a pole piece denoted by 1702. The pole piece 1702 protrudes from the return member 1700 and may be manufactured from a separate piece of material than the return member 1700 and may be attached to the return member 1700. Alternatively, the pole piece 1702 may be formed from a single piece of material together with the return member 1700. In case of the presence of a second return member, another pole piece is arranged at the second return member.

In the embodiment of FIG. 8a the pole piece 1702 and the return member 1700 both have the same width W1=W3 which width W1 is smaller than the width W2 of the magnet assembly 1570. In FIG. 8b the pole piece 1702 has a width W1 different to—and in particular smaller than—the width W3 of the return member 1700.

In another preferred embodiment, at least parts of the return path structure are made of one of a mu-metal or silicon steel. Preferably, the entire return path structure, i.e. the pole piece, the return member and the coil core, is made of a mu-metal or silicon steel. By such choice of material a hysteresis existent in the motion versus drive may be improved. Mu-metal or silicon-steel provide for a low magnetic hysteresis as a result of which the mechanical hysteresis of the tiltable tape guide roller may be reduced. Mu-metal typically includes a nickel-iron alloy that has a very high magnetic permeability. Silicon steel typically is steel treated to exhibit a high magnetic permeability. Other low hysteresis soft magnetic material may be used, too.

1. A tape guide roller, comprising:
a first support frame including a return path structure formed of a magnetically permeable material,
a second support frame pivotally coupled to the first support frame,
an actuator for tilting the first support frame against the second support frame, the actuator comprising
a coil supported by said first support frame for conducting an electric current to generate a magnetic field conducted by the return path structure, and
a permanent magnet assembly supported by the second support frame, the magnet assembly facing a pole piece of the return path structure,
wherein a width (W1) of the pole piece is smaller than a width (W2) of the magnet assembly.

2. Tape guide roller according to claim 1,
wherein the width (W1) of the pole piece is half of the width (W2) of the magnet assembly.

3. Tape guide roller according to claim 1,
wherein the width (W1) of the pole piece is within a range of 20% to 80% of the width (W2) of the magnet assembly.

4. Tape guide roller according to claim 1,
wherein the width (W1) of the pole piece is within a range of 30% to 70% of the width (W2) of the magnet assembly.

5. Tape guide roller according to claim 1,
wherein the width (W1) of the pole piece is within a range of 40% to 60% of the width (W2) of the magnet assembly.

6. Tape guide roller according to claim 1,
wherein the width (W1) of the pole piece is within a range of 45% to 55% of the width (W2) of the magnet assembly.

7. Tape guide roller according to claim 1,
wherein the return path structure includes a core around which the coil is wound and a member extending from the core, wherein the pole piece is arranged at the end of the member.

8. Tape guide roller according to claim 7,
wherein the pole piece is an element manufactured separate from the member, and wherein the pole piece is attached to the member.

9. Tape guide roller according to claim 7,
wherein the width (W1) of the pole piece is smaller than a width (W3) of the member.

10. Tape guide roller according to claim 7,
wherein the return path structure includes a second member parallel to the first member each member extending from an end of the core, and wherein the magnet assembly extends between the members of the return path structure.

11. Tape guide roller according to claim 1,
wherein the magnet assembly comprises a first and a second permanent magnet supported by the second support frame, wherein the second support frame is pivotally coupled to the first support frame at a pivot point located between the first and second magnets.

12. Tape guide roller according to claim 1,
wherein the magnet assembly comprises one or more magnets with a face facing the pole piece, the face comprising portions of opposite magnetic polarity.

13. Tape guide roller according to claim 1,
wherein at least parts of the return path structure is made of one of a mu-metal or a silicon steel.

14. Tape guide roller according to claim 1,
wherein the actuator is designed such that magnetic attraction between the magnet assembly and the return path structure holds the second support frame and a tape roller barrel in a first position relative to the first support frame and that current conducted through a coil generates a magnetic field which is conducted by the return path structure to interact with the magnetic field of the magnet assembly which causes the second support frame and the tape roller barrel to pivot relative to the first support frame as a function of the magnitude and direction of the current through the coil.

15. Tape guide roller according to claim 1,
wherein the second support frame supports a rotatable tape roller barrel that guides a tape of a tape storage system, which tape roller barrel has a grooved surface.

16. A tape drive system, comprising:
a tape head,
a tape drive for moving a tape inserted into the tape drive in a longitudinal direction across the tape head,
a tape position sensor for detecting a lateral position of the tape,
a tape guide roller, and
a controller responsive to the tape position sensor for controlling the current through a coil to tilt a tape roller barrel to control the lateral position of the tape wherein the tape guide roller is formed of:
a first support frame including a return path structure formed of a magnetically permeable material,
a second support frame pivotally coupled to the first support frame,
an actuator for tilting the first support frame against the second support frame, the actuator comprising
a coil supported by said first support frame for conducting an electric current to generate a magnetic field conducted by the return path structure, and
a permanent magnet assembly supported by the second support frame, the magnet assembly facing a pole piece of the return path structure,
wherein a width (W1) of the pole piece is smaller than a width (W2) of the magnet assembly, and
wherein the actuator is designed such that magnetic attraction between the magnet assembly and the return path structure holds the second support frame and the tape roller barrel in a first position relative to the first support frame and that current conducted through the coil generates a magnetic field which is conducted by the return path structure to interact with the magnetic field of the magnet assembly which causes the second support frame and the tape roller barrel to pivot relative to the first support frame as a function of the magnitude and direction of the current through the coil.
